(19) United States
(12) Patent Application Publication
(10) Pub. No.: US 2012/0120783 A1
(43) Pub. Date: May 17, 2012

(54) GUIDE-LAYER SEPARATED OPTICAL DISK, OPTICAL DISK DRIVE APPARATUS, AND TRACKING CONTROL METHOD

(75) Inventor: Kazuo Takahashi, Hanno (JP)

(73) Assignee: Pioneer Corporation, Kawasaki-shi, Kanagawa (JP)

(21) Appl. No.: 13/381,713

(22) PCT Filed: Jul. 10, 2009
(86) PCT No.: PCT/JP2009/062605

§ 371 Date: Feb. 7, 2012

(51) Int. Cl. G11B 7/007; G11B 7/00

(52) U.S. Cl. 369/44.25; 369/275.1; G9B/7.03; G9B/7.062

(57) ABSTRACT

A guide-layer separated optical disk which includes a guide layer having a guide structure whose tracking guide tracks are divided into areas by discontinuous portions, the areas each having concentric guide tracks of arc shape at a regular track pitch, the guide tracks in adjoining two of the areas across one of the discontinuous portions deviating from each other in a radial direction of the disk by ¼ the track pitch. An optical disk drive apparatus and a tracking control method in which a servo optical system switches the tracking center of the irradiation spot of a first laser beam between on the guide tracks and in between the guide tracks alternately each time the irradiation spot passes two of the discontinuous portions.

### TECHNICAL FIELD

The present invention relates to a guide-layer separated optical disk having a plurality of recording layers, a drive apparatus of the optical disk, and a tracking control method.

### BACKGROUND ART

There are known optical disks that have multiple recording layers. Examples include an optical disk of guide-layer integral type in which recording layers and guide layers are formed in the same respective recording layers, and a guide-layer separated optical disk in which recording layers are formed separate from a guide layer. The guide layer is a layer in which a servo guide structure or signal that contains position (address) information is formed as guide tracks.

In the disk of guide-layer integral type, the guide tracks integral with the recording layers can be used to perform tracking control even on unrecorded areas of the recording layers where no information is recorded. Information can thus be recorded on any tracks that are defined by the guide tracks. Another advantage is that information can be recorded and reproduced by using a single laser beam.

The guide-layer separated optical disk needs both a servo laser beam for reading guide tracks from the guide layer and a read/write laser beam for writing information or reading recorded information on/from the recording layers. When recording information on one of the recording layers, the focal position of the servo laser beam is moved along the guide tracks of the guide layer through tracking control while the read/write laser beam is focused on the one recording layer for information writing (see Patent Reference 1). For that purpose, the optical disk drive apparatus includes a servo optical system and a read/write optical system. The servo optical system is intended to irradiate the guide layer with the servo laser beam and detect the reflected light. The read/write optical system is intended to irradiate the recording layers with the read/write laser beam and detect the reflected light by using the same objective lens of the servo optical system. The guide-layer separated optical disk is composed of a stack of simply-structured recording layers, and can thus be manufactured easily with low manufacturing cost. It is also advantageous that as compared to the disk of guide-layer integral type, the number of recording layers can be easily increased for greater storage capacity.
Patent Reference 1: Japanese Patent Application Publication No. 2001-202630

### DISCLOSURE OF THE INVENTION

### Problems to be Solved by the Invention

In the guide-layer separated optical disk, however, the servo laser beam that the servo optical system uses for tracking the guide tracks of the guide layer typically has a wavelength longer than that of the read/write laser beam. Since the servo optical system has lower resolution than the read/write optical system, there has been the problem that it is difficult to form a recording track of spiral shape at high density corresponding to the resolution of the read/write optical system.

The foregoing disadvantage is one of the problems to be solved by the present invention. It is thus an object of the present invention to provide a guide-layer separated optical disk, an optical disk drive apparatus, and a tracking control method that are capable of forming a recording track of spiral shape on the recording layers at high density.

### Means for Solving the Problems

A guide-layer separated optical disk according to the present invention of claim 1 is a guide-layer separated optical disk, comprising: a guide layer having a guide structure; and a plurality of recording layers stacked separate from the guide layer, wherein tracking guide tracks of the guide structure are divided into areas by discontinuous portions, the areas each have concentric guide tracks of arc shape at a regular track pitch, and the guide tracks in adjoining two of the areas across one of the discontinuous portions deviates from each other in a radial direction of the disk by ¼ the track pitch.

An optical disk drive apparatus according to the present invention of claim 4 is an optical disk drive apparatus for driving a guide-layer separated optical disk, the optical disk including a guide layer having a guide structure and a plurality of recording layers stacked separate from the guide layer, tracking guide tracks of the guide structure being divided into areas by discontinuous portions, the areas each having concentric guide tracks of arc shape at a regular track pitch, the guide tracks in adjoining two of the areas across one of the discontinuous portions deviating from each other in a radial direction of the disk by ¼ the track pitch, the optical disk drive apparatus comprising: a servo optical system for irradiating the optical disk with a first laser beam for servo control through an objective lens to detect reflected light from the guide layer; and a read/write optical system for irradiating the optical disk with a second laser beam for reading or writing through the objective lens to detect reflected light from one of the plurality of recording layers, wherein the servo optical system includes tracking servo control means for switching a tracking center of an irradiation spot of the first laser beam between on the guide track and in between the guide tracks alternately each time the irradiation spot passes two of the discontinuous portions.

A tracking control method according to the present invention of claim 11 is a tracking control method of an optical disk drive apparatus, the optical disk drive apparatus including: a servo optical system that irradiates a guide-layer separated optical disk with a first laser beam for servo control through an objective lens and detects reflected light from a guide layer of the optical disk, the optical disk including the guide layer and a plurality of recording layers stacked separate from the guide layer, the guide layer having a guide structure, tracking guide tracks of the guide structure being divided into areas by discontinuous portions, the areas each having concentric guide tracks of arc shape at a regular track pitch, the guide tracks in adjoining two of the areas across one of the discontinuous portions deviating from each other in a radial direction of the disk by ¼ the track pitch; and a read/write optical system that irradiates the optical disk with a second laser beam for reading or writing through the objective lens and detects reflected light from any one of the plurality of recording layers, the tracking control method comprising the step of allowing the servo optical system to switches a tracking center of an irradiation spot of the first laser beam between on the guide tracks and in between the guide tracks alternately each time the irradiation spot passes two of the discontinuous portions.

### BEST MODE FOR CARRYING OUT THE INVENTION

According to the optical disk of the present invention of claim 1, the tracking guide tracks of the guide structure of the guide layer are divided into areas by the discontinuous portions. The areas each have concentric guide tracks of arc shape at a regular track pitch. The guide tracks in adjoining two of the areas across one of the discontinuous portion deviate from each other in the radial direction of the disk by ¼ the track pitch. Such a configuration makes it possible to form a recording track of spiral shape on the recording layers at high density by switching the tracking center from a land to a groove or from a groove to a land for each passages of two discontinuous portions.

According to the optical disk drive apparatus of the present invention of claim 4 and the tracking control method of the present invention of claim 11, the servo optical system switches the tracking center of the irradiation spot of the first laser beam between on the guide tracks and in between the guide tracks alternately each time the irradiation spot passes two of the discontinuous portions. This makes it possible to form a recording track of spiral shape on the recording layers at high density.

### BRIEF DESCRIPTION OF THE DRAWINGS

FIG. 1 is a view illustrating a partial section of a guide-layer separated optical disk according to the present invention;

FIGS. 2A, 2B, and 2C are views illustrating a guide layer of the optical disk of FIG. 1;

FIG. 3 is a view illustrating the configuration of a cutting apparatus;

FIG. 4 is a view illustrating the operation of cutting guide tracks in the guide layer;

FIG. 5 is a view illustrating the configuration of an optical disk drive apparatus according to the present invention;

FIG. 6 is a view illustrating the configuration of a tracking error signal generation section in the apparatus of FIG. 5;

FIG. 7 is a view illustrating the configuration of a tracking control section in the apparatus of FIG. 5;

FIG. 8 is a view illustrating the relationship between the position of a beam spot and a tracking error signal;

FIG. 9 is a view illustrating variations of the tracking error signal when the beam spot traverses the guide tracks;

FIG. 10 is a flowchart showing the control operation of a main controller in recording mode;

FIG. 11 is a flowchart showing a control operation on discontinuous portions when tracking servo control is on;

FIG. 12 is a view illustrating a tracking servo control on the guide tracks including the discontinuous portions;

FIGS. 13A and 13B are views illustrating the movement of the beam spot in the discontinuous portions when the beam spot traces the guide tracks clockwise;

FIG. 14 is a view illustrating a recording track of spiral shape formed on a recording layer;

FIG. 15 is a chart showing variations of a recording position when the recording position is moved from the inner side to outer side;

FIG. 16 is a view illustrating the setting of a target value and the movement of the beam spot in the discontinuous portions of the guide tracks when forming a recording track of spiral shape that makes a constant change;

FIGS. 17A and 17B are views illustrating the movement of the beam spot in the discontinuous portions when the beam spot traces the guide tracks clockwise while forming a recording track of spiral shape with a constant change;

FIG. 18 is a view illustrating variations of the tracking target value and tracking polarity when forming a recording track of spiral shape with a constant change from the inner side to outer side;

FIG. 19 is a view illustrating variations of the tracking target value and tracking polarity when forming a recording track of spiral shape with a constant change from the outer side to inner side;

FIGS. 20A and 20B are views illustrating the movement of the beam spot in the discontinuous portions when the beam spot traces the guide tracks clockwise on an optical disk in which the guide layer is divided into four areas; and

FIG. 21 is a view illustrating another example of formation of discontinuous portions in the guide layer of an optical disk.

### EMBODIMENTS

Hereinafter, an embodiment of the present invention will be described in detail with reference to the drawings.

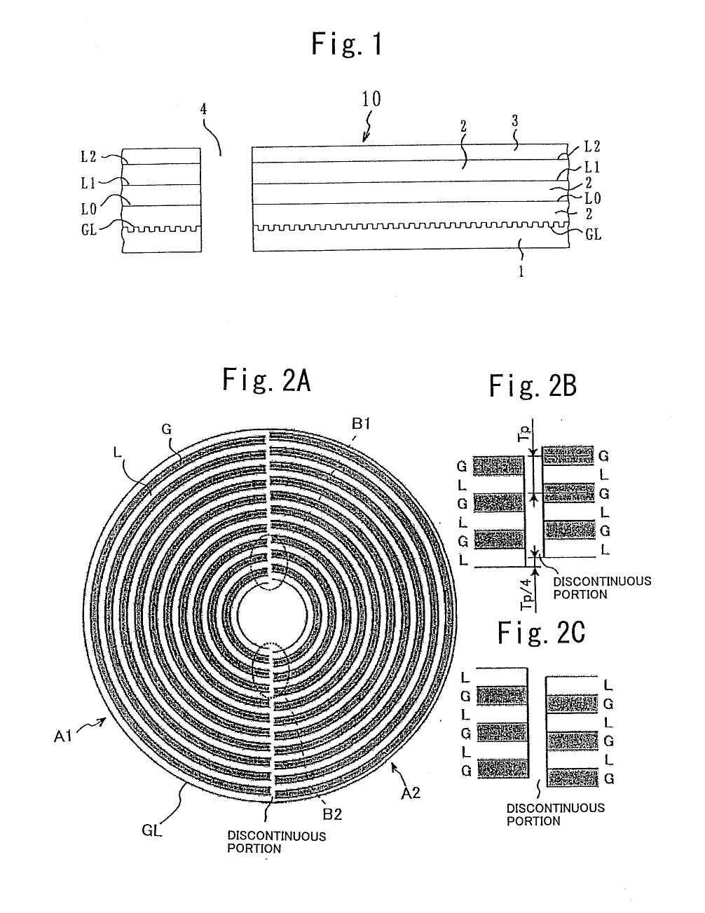

FIG. 1 shows a guide-layer separated optical disk 10 which is an embodiment of the present invention. As shown in FIG. 1, the optical disk 1 has a layered structure including a glass substrate 1, a guide layer GL, three recording layers L0 to L2, inter-layers 2, and a protection layer 3. The guide layer GL is formed on the substrate 1 and is made of a reflective coating. The recording layers L0 to L2 are made of a semitransparent reflective coating and a recording layer each, and are formed in that order from the guide layer GL side. The inter-layers 2 are made of UV cured resin, and are formed between the guide layer GL and the recording layers L0 to L2, respectively. The reflective coating of the guide layer GL is made of metal such as Au. The recording films of the recording layers L0 to L2 are made of an organic material such as azo dye. The semitransparent reflective coatings are made of dielectric such as Nb₂O₅ and TiO₂. The protection layer 3 is formed on the recording layer L2, and forms a disk surface for laser light to be incident on. A clamp hole 4 is formed through the center of the optical disk 10.

A groove-based guide structure is formed over the entire surface of the guide layer GL. The guide structure is a structure for recording information in a spiral fashion on the recording layers which have no guide structure. The grooves constitute guide tracks, on which address information is recorded in the form of wobbles or the like. Lands are formed between adjoining guide tracks.

As shown in FIG. 2A, the guide layer GL has two areas A1 and A2, which are equal halves divided by a straight line that passes the center point of the disk. The areas A1 and A2 each have lands L and grooves G of arc shape which are formed alternately at the same pitch from the inner side to outer side. The centers of the circular arcs fall on the center point of the disk. The parting line between the areas A1 and A2 is where both the lands L and the grooves G are discontinuous.

FIGS. 2B and 2C are enlarged views of parts B1 and B2 of the guide layer GL, respectively. The lands L and grooves G each have a width of Tp/2, where Tp is the track pitch of the grooves G. As shown in FIGS. 2B and 2C, the lands L and grooves G formed in the areas A1 and A2 differ in position by Tp/4 in the radial direction of the disk. More specifically, the positions of the lands L and grooves G formed in the area A2 are shifted outward by Tp/4 (one half the width of both the lands L and grooves G) with respect to those of the lands L and grooves G formed in the areas A1.

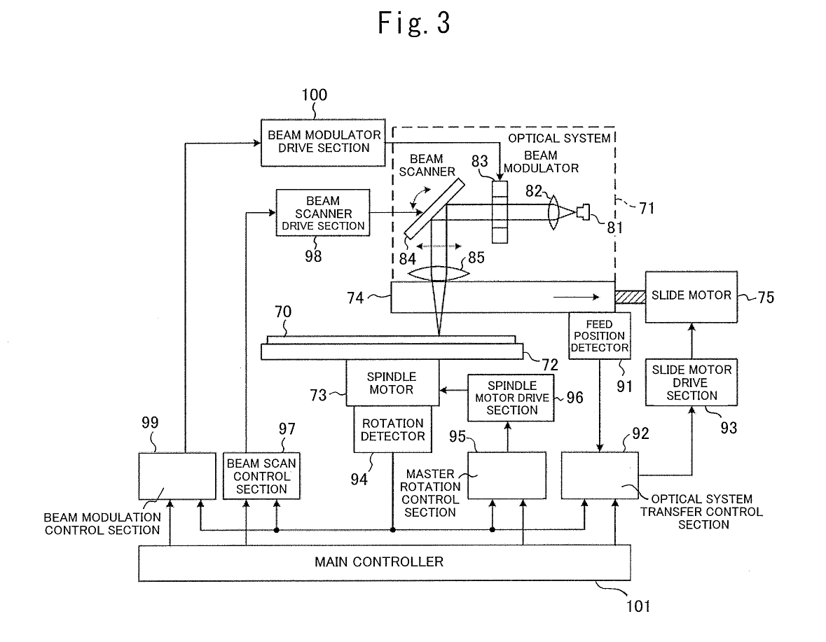

The guide layer GL of the optical disk 10 shown in FIGS. 1 and 2A is molded by using a die (stamper) that is shaped to the guide tracks, followed by the deposition of the reflective coating. The stamper is typically formed in the order of the following steps: glass substrate cleaning, photoresist formation, exposure, development, conductive treatment, and nickel electroforming. Of such steps, the exposure step is referred to as cutting, in which the guide tracks are recorded by the same method as with ordinary optical disks such as DVD. A cutting apparatus for use in the exposure step is configured as shown in FIG. 3.

The cutting apparatus, as shown in FIG. 3, includes an optical system 71, a turntable 72, a spindle motor 73, a slide table 74, and a slide motor 75. The optical system 71 includes a light source 81, a collimator lens 82, a beam modulator 83, a beam scanner 84, and an objective lens 85.

The cutting apparatus also has a control system which includes a feed position detector 91, an optical system transfer control section 92, a slide motor drive section 93, a rotation detection section 94, a master rotation controller 95, a spindle motor drive section 96, a beam scan control section 97, a beam scanner driver 98, a beam modulation control section 99, a beam modulator driver 100, and a main controller 101.

A master 70 is loaded on the turntable 72. The master 70 is a glass substrate disk with a resist applied thereto, being formed by the foregoing glass substrate cleaning step and photoresist formation step. The light source 81 is a laser having a wavelength of 350 nm, for example. The laser light is collimated into a parallel laser beam through the collimator lens 82. The beam modulator 83 transmits or blocks the laser beam with a mechanism such as a shutter, for example. The beam modulator 83 can be modulated at high speed for pit recording. In the present embodiment, the cutting apparatus cuts grooves G as guide tracks. The beam scanner 84 can reflect the laser beam toward the objective lens 85 with a mechanism such as a galvanometer mirror. The beam scanner 84 can also scan the direction of irradiation of the laser beam in the radial direction of the master 70. An acousto-optic modulator (AOM) can be used to provide the functions of both the beam modulator 83 and the beam scanner 84. The objective lens 85 converges the laser beam onto the resist on the master 70, whereby the master 70 is exposed (recorded) to the converged beam spot.

The slide table 72 lies under a mechanism to which the optical system 71 is fixed and which transfers the optical system 71 in the radial direction of the maser 70 by using the slider motor 75. The feed position detector 91 detects the amount of movement of the turntable 72 by using a position sensor or the like, for example, and outputs a transfer amount detection signal. The optical system transfer control section 92 generates a transfer controls from the transfer amount detection signal, for example, so as to make the speed constant. The slide motor drive section 93 drives the slide motor 75 in accordance with the transfer control signal, whereby the optical system 71 is transferred in the radial direction of the master 70 at constant speed.

The turntable 72 has a mechanism for holding the master 70, and a structure for rotating the master 70 with the spindle motor 73. The rotation detection section 94 outputs a rotation synchronizing signal, for example, by using a rotary encoder which is attached to the spindle motor. The rotation synchronizing signal is used for rotation control on the spindle motor 73 and for beam scan control on the beam scanner 84. Based on the rotation synchronizing signal, the master rotation controller 95 generates a rotation control signal so as to make the number of rotations constant, for example. The spindle motor drive section 96 drives the spindle motor 73 in accordance with the rotation control signal, whereby the master 70 is rotated at a constant number of rotations.

In order to scan the beam spot in the radial direction of the master 70 in synchronization with the rotation of the master 70, the beam scan control section 97 generates a beam scan control signal. The beam scanner driver 98 drives the beam scanner 84 to scan the laser beam in accordance with the beam scan control signal, whereby the converged beam spot is scanned in the radial direction of the master 70. For example, when recording a circular guide track (groove), the beam scanner 84 scans the beam spot at the same speed as the transfer speed of the optical system 71 in the opposite direction. In such a case, the beam spot appears to be stationary in the radial direction of the master 70. If the amount of scanning of the beam spot by the beam scanner 84 for one track pitch is cancelled out once for each rotation, the beam spot proceeds in the radial direction of the master 70 by one track pitch. The procedure can be repeated to cut concentric guide tracks. That is, when cutting concentric guide tracks, the beam spot is scanned in a sawtooth shape at cycles of one rotation.

In synchronization with the rotation of the master 70, the beam modulation control section 99 generates a beam modulation control signal for controlling exposure timing. The beam modulator driver 100 drives the beam modulator 83 in accordance with the beam modulation control signal, whereby the laser beam is transmitted/blocked to turn exposure on/off. For example, when cutting concentric guide tracks, exposure is turned off while the amount of scanning of the beam spot by the beam scanner 84 for one track pitch is cancelled out once for each rotation.

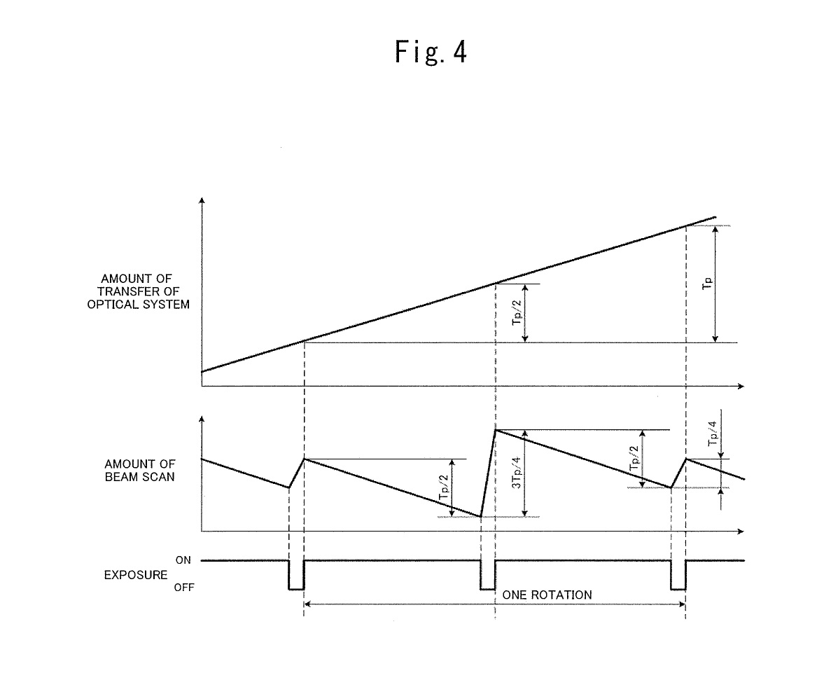

FIG. 4 shows the operation of cutting guide tracks in the guide layer GL that is formed on the optical disk 10 of FIG. 1.

The guide tracks of FIG. 1 have a constant track pitch Tp. The optical system 71 is thus transferred together with the slide table 74 at such a constant speed as proceeds by one track pitch Tp per rotation. If the beam scanner 84 scans the beam spot at the same speed in the opposite direction, the beam spot is stationary in the radial direction of the master 70. The guide tracks of FIG. 1 have two discontinuous portions per round, i.e., at every 180 degrees. When cutting the guide tracks clockwise from the inner side to outer side, the beam scan is retracted by ¼ the track pitch Tp in either one of the discontinuous portions so that the guide track is shifted outward by ¼ the track pitch Tp. In the other discontinuous portion, the beam scan is retracted by ¾ the track pitch Tp so that the guide track is shifted outward by ¾ the track pitch Tp. The exposure is turned off while the beam scan is retracted. Such a procedure can be repeated by each rotation to cut the guide tracks such as shown in FIG. 1.

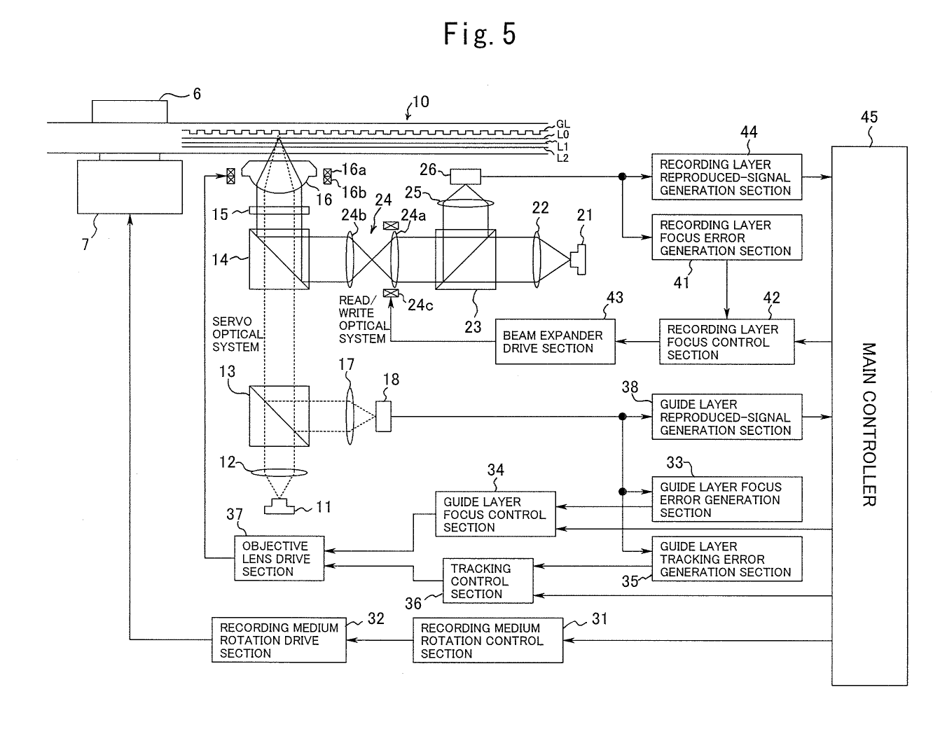

FIG. 5 shows the configuration of an optical disk drive apparatus according to the present invention. The optical disk drive apparatus optically records and reproduces information on/from the foregoing optical disk 10. The optical disk drive apparatus includes a disk drive assembly, an optical system, and a signal processing assembly.

The disk drive assembly includes a structure that catches and holds the optical disk 10 with a clamp mechanism 6, and rotates the same with the spindle motor 7.

The optical system is subdivided into a servo optical system and a read/write optical system.

The servo optical system includes a light source 11, a collimator lens 12, a beam splitter 13, a dichroic prism 14, a wave plate 15, an objective lens 16, a condenser lens 17, and a photodetector 18.

The light source 11 is a semiconductor laser device that emits a servo laser beam having a wavelength of 660 nm. The light source 11 is driven by a not-shown servo light source drive section. The collimator lens 12 converts the servo laser beam emitted from the light source 11 into parallel light, and supplies it to the beam splitter 13. The beam splitter 13 simply supplies the parallel laser beam supplied from the collimator lens 12 to the dichroic prism 14. The dichroic prism 14 is a composite prism having a composite surface that varies in reflection and transmission characteristics depending on the wavelength of light. The composite surface characteristically reflects light at wavelengths of around 405 nm which is the wavelength of the read/write laser beam, and transmits light at wavelengths of around 660 nm which is the wavelength of the servo laser beam, i.e., the guide light. The dichroic prism 14 therefore simply supplies the servo laser beam incident from the beam splitter 13 to the wave plate 15.

The laser beam passes the wave plate 15 twice on the way to the optical disk 10 and on the way back from the optical disk 10, whereby the direction of polarization of the beam is changed by 90 degrees. This means that the servo return light from the dichroic prism 14 to the splitting surface of the beam splitter 13 is s-polarized. It follows that the beam splitter 13 functions to reflect the returning beam. The same holds for read/write return light in a beam splitter 23 of the read/write optical system to be described later. The wave plate 15 in use is of wideband type, and functions as a quarter-wave plate at least at the wavelength of the beam emitted from the light source 11 and that of the beam emitted from a light source 21 to be described later.

The objective lens 16 is provided with a focus actuator 16a that is intended for movement in the direction of the optical axis, and a tracking actuator 16b that is intended for movement in a direction perpendicular to the optical axis. The objective lens 16 can be electrically controlled to make small movements in the focus direction and tracking direction.

With the focus actuator 16a, the objective lens 16 can bring the servo laser beam into convergence on the guide layer of the optical disk 10, and at the same time focus the read or write laser beam on any one of the plurality of recording layers L0 to L2. With the tracking actuator 16b, the objective lens 16 can position the light spot of the servo laser beam on a guide track on the guide layer GL, and at the same time irradiate the one recording layer with the light spot of the read or write laser beam at the position corresponding to the guide track.

The servo laser beam reflected by the guide layer of the optical disk 10 returns to the dichroic prism 14 as a parallel laser beam through the objective lens 16 and the wave plate 15. The dichroic prism 14 simply supplies the reflected servo laser beam to the beam splitter 13. The beam splitter 13 reflects the laser beam from the dichroic prism 14 at an angle of approximately 90 degrees with respect to the incidence, and supplies the laser beam to the condenser lens 17. The condenser lens 17 converges the reflected servo laser beam to the light receiving surface of the photodetector 18 to form a spot thereon. The photodetector 18 has a four-way split light receiving surface, for example. The photodetector 18 generates voltage signals having levels corresponding to the intensities of light received at the respective split surfaces.

The read/write optical system shares the dichroic prism 14, the wave plate 15, and the objective lens 16 with the servo optical system. In addition, the read/write optical system includes a light source 21, a collimator lens 22, a beam splitter 23, a beam expander 24, a condenser lens 25, and a photodetector 26.

The light source 21 is a semiconductor laser device that emits a read or write laser beam having a wavelength of 405 nm. The light source 21 is driven by a not-shown read/write light source drive section. The laser beam emitted from the light source 21 is adjusted to p-polarization. The collimator lens 22 converts the laser beam emitted from the light source 21 into parallel light, and supplies it to the beam splitter 23. The beam splitter 23 is a polarizing beam splitter (PBS), and has a splitting surface at 45 degrees with respect to the surface on which the laser beam from the collimator lens 22 is incident. The p-polarized parallel laser beam supplied from the collimator lens 22 is simply transmitted through the splitting surface and supplied to the beam expander 24.

The beam expander 24 is composed of Keplerian expander lenses, including first and second correcting lenses 24a and 24b. The first correcting lens 24a is driven by an actuator 24c so that it can move in the direction of the optical axis. In an initial state, the lens spacing is adjusted so that incident parallel light is emitted as parallel light. The movement of the correcting lens 24a in the direction of the optical axis changes the beam to be emitted into divergent light or convergent light, which can give the read/write laser beam a difference in focus from the servo laser beam when converged by the objective lens 16. Spherical aberration can also be given. That is, the position of the first correcting lens 24a can be changed to change the distance between the first and second correcting lenses 24a and 24b, whereby focus control and spherical aberration correction can be made for each recording layer of the optical disk 10. Spherical aberration correcting means alternative to the beam expander 24 include Galilean expander lenses and liquid crystal devices.

The dichroic prism 14, as mentioned previously, reflects light at wavelengths of around 405 nm which is the wavelength of the read/write laser beam. The read/write laser beam is thus reflected toward the optical disk 10.

The objective lens 16, as mentioned previously, can focus the read or write laser beam on any one of the plurality of recording layers L0 to L2.

The read/write laser beam reflected by the one of the recording layers of the optical disk 10 returns to the beam splitter 23 as a parallel laser beam through the objective lens 16, the wave plate 15, the dichroic prism 14, and the beam expander 24. Since the reflected laser beam is s-polarized, the splitting surface of the beam splitter 23 reflects the reflected laser beam at an angle of approximately 90 degrees with respect to the incidence, and supplies the reflected laser beam to the condenser lens 25. The condenser lens 25 converges the reflected laser beam to the light receiving surface of the photodetector 26 to form a spot thereon. The photodetector 26 has a four-way split light receiving surface, for example. The photodetector 26 generates voltage signals having levels corresponding to the intensities of light received at the respective split surfaces.

It should be noted that the optical systems described above are configured so that they can be moved in the radial direction of the optical disk 10 by a not-shown transfer drive section.

The signal processing assembly includes a recording medium rotation control section 31, a recording medium rotation drive section 32, a guide layer focus error generation section 33, a guide layer focus control section 34, a guide layer tracking error generation section 35, a tracking control section 36, an objective lens drive section 37, a guide layer reproduced-signal generation section 38, a recording layer focus error generation section 41, a recording layer focus control section 42, a beam expander drive section 43, a recording layer reproduced-signal generation section 44, and a main controller 45.

The recording medium rotation control section 31 controls the recording medium rotation drive section 32 in accordance with an instruction from the main controller 45. At recording medium drive time, the recording medium rotation drive section 32 drives the motor 7 for rotation, whereby the optical disk 10 is rotated. The recording medium rotation drive section 32 performs spindle servo control so as to rotate the optical disk 10 at a constant linear velocity.

The guide layer focus error generation section 33 generates a guide layer focus error signal in accordance with the output voltage signals of the photodetector 18. The focus error signal can be generated, for example, by using a known signal generation method such as an astigmatic method. The guide layer focus error signal is a signal that has S-characteristics which comes to a zero level when the focal position of the servo beam falls on the guide layer GL.

The guide layer focus control section 34 makes a control operation in accordance with an instruction from the main controller 45, and generates a focus control signal at focus servo control time so that the guide layer focus error signal comes to the zero level. The focus control signal is supplied to the objective lens drive section 37 for the sake of focus-related control on the objective lens 16.

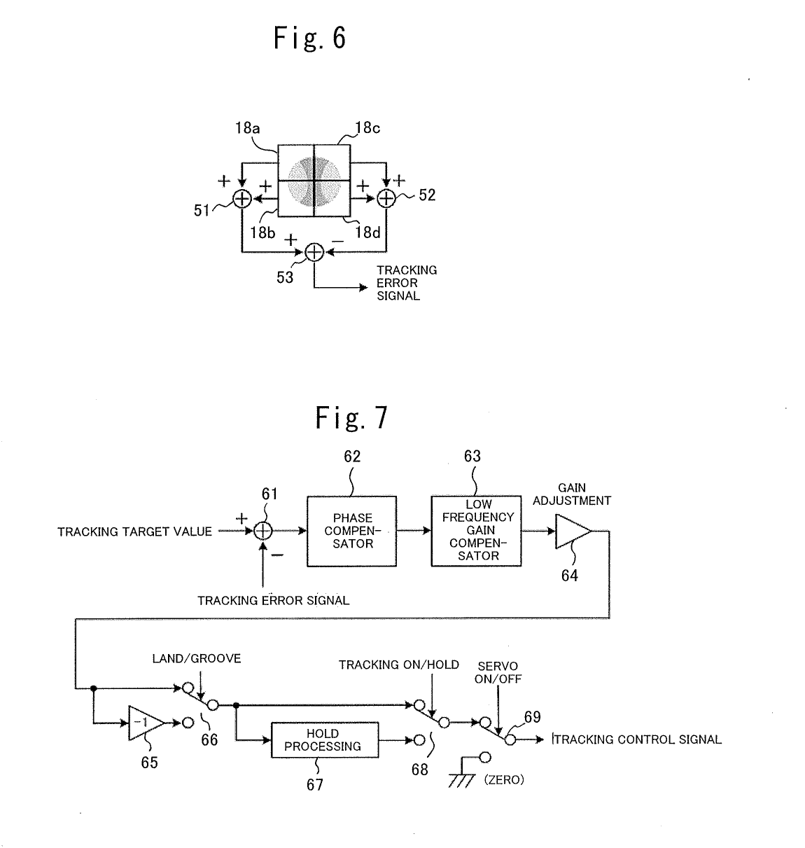

The guide layer tracking error generation section 35 generates a guide layer tracking error signal in accordance with the output voltage signals of the photodetector 18. The guide layer tracking error signal is a signal that indicates an error in the position of the spot of the servo laser beam converged on the guide layer GL with respect to the guide track center of the land or groove. For example, suppose, as shown in FIG. 6, that the light receiving surface of the photodetector 18 is divided into four equal parts along the radial direction of the disk and the track tangential direction perpendicular thereto. In such a case, the output signals of the photodetector elements 18a and 18b lying on the inner side of the track tangential direction are added by an adder 51. The output signals of the photodetector elements 18c and 18d lying on the outer side of the track tangential direction are added by an adder 52. A subtractor 53 calculates a difference between the output signal of the adder 51 and that of the adder 52, thereby generating the guide layer tracking error signal.

The output of the guide layer tracking error generation section 35 is connected to the tracking control section 36. The tracking control section 36 performs tracking servo control in accordance with an instruction from the main controller 45. The tracking control section 36 accepts the guide layer tracking error signal generated by the guide layer tracking error generation section 35, and supplies a tracking control signal to the objective lens drive section 37 for the sake of tracking-related control on the objective lens 16. The tracking control signal is generated at tracking servo control time so that the guide layer tracking error signal comes to the level of a tracking target value.

Specifically, as shown in FIG. 7, the tracking control section 36 includes a subtractor 61, a phase compensator 62, a low frequency gain compensator 63, a gain adjuster 64, a polarity inverter 65, a land/groove switcher 66, a hold processing section 67, a tracking servo/hold switcher 68, and a tracking on/off switcher 69. The subtractor 61 calculates a difference in level between the tracking target value and the tracking error signal. The phase compensator 62 gives a phase lead to the output signal of the subtractor 61, thereby ensuring the stability of the tracking servo control. The low frequency gain compensator 63 boosts the low frequency component of the output signal of the phase compensator 62 in gain, thereby improving the suppression performance on low-frequency disturbances such as eccentricity. The gain adjuster 64 adjusts the gain of the output signal of the low frequency gain compensator 63 for stable servo control. The polarity inverter 65 inverts the polarity of the output signal of the gain adjuster 64.

The land/groove switcher 66 outputs either one of the output signals of the gain adjuster 64 and the polarity inverter 65 in accordance with a land/groove select signal from the main controller 45. Selecting the polarity of the tracking servo determines which to track, the lands L or the grooves G. To track the grooves G, the output signal of the gain adjuster 64 is selected by the land/groove switcher 66. To track the lands L, the output signal of the polarity inverter 65 is selected by the land/groove switcher 66.

The hold processing section 67 holds and outputs the output signal of the land/groove switcher 66 immediately before switching of the tracking servo/hold switcher 68 from the servo side to the hold side. At tracking servo control time, the tracking servo/hold switcher 68 is switched to the servo side to relay the output signal of the land/groove switcher 66. At tracking hold control time, the tracking servo/hold switcher 68 is switched to the hold side to relay the held output signal from the hold processing section 67.

When tracking control is on, the tracking on/off switcher 69 outputs the output signal of the tracking servo/hold switcher 68 as the tracking control signal. When tracking control is off, the tracking on/off switcher 69 outputs a zero level as the tracking control signal.

The objective lens drive section 37 drives the focus actuator 16a in accordance with the focus control signal from the guide layer focus control section 34, thereby moving the objective lens 16 in the direction of the optical axis so that the servo beam is converged to form a beam spot on the guide layer GL. The objective lens drive section 37 also drives the tracking actuator 16b in accordance with the tracking control signal from the tracking control section 36, thereby moving the objective lens 16 in the radial direction of the optical disk 10 perpendicular to the optical axis so that the servo beam spot traces the guide track of the guide layer GL.

The guide layer reproduced-signal generation section 38 reads recorded data (wobbles) on the guide track in accordance with the output voltage signals of the photodetector 18, and generates the address information. The guide layer reproduced-signal generation section 38 detects the discontinuous portions of the guide layer GL from the output voltage signals of the photodetector 18, and generates a timing signal. The discontinuous portions are detected by applying a push-pull signal to the circumferential direction by the same method as with the generation of the tracking error signal, or by reading the data to check the read position. The timing signal is used in the main controller 45 for such purposes as switching the polarity of the tracking error and switching the tracking servo control between on, off, and hold.

The recording layer focus error generation section 41 generates a recording layer focus error signal in accordance with the output voltage signals of the photodetector 26. The recording layer focus error signal can be generated, for example, by using a known signal generation method such as an astigmatic method. The recording layer focus error signal is a signal that has S-characteristics which comes to a zero level when the focal position of the read/write beam falls on each of the recording layers L0 to L2. The output of the recording layer focus error signal generation section 41 is connected to the recording layer focus control section 42. In accordance with the recording layer focus error signal, in reproducing mode, the recording layer focus control section 42 supplies a recording layer focus control signal to the beam expander drive section 43 for control. The recording layer focus drive signal is generated so that the recording layer focus error signal comes to the zero level when the recording layer is under focus servo control.

The beam expander drive section 43 drives the actuator 24c to change the distance between the correcting lenses 24a and 24b of the beam expander in accordance with the recording layer focus control signal. The beam expander 43 thereby adjusts the divergence/convergence of the beam that travels toward the objective lens 16, and changes the converged position of the read/write beam with respect to the converged position of the serve beam on the optical axis. That is, a voltage level corresponding to a desired recording layer is supplied to the beam expander drive section 43 as the recording layer focus control signal so that the read/write beam is converged to any one of the recording layers at a desired distance from the guide layer GL.

The recording layer reproduced-signal generation section 44 reproduces the signal recorded on any one of the recording layers in accordance with the output voltage signals of the photodetector 26.

The main controller 45 controls on/off the disk rotation control of the recording medium control section 31, the focus servo control of the guide layer focus control section 34, and the focus servo control of the recording layer focus control section 42. The main controller 45 also controls the switching of each of the land/groove switcher 66, the tracking servo/hold switcher 68, and the tracking on/off switcher 69 in the tracking control section 36.

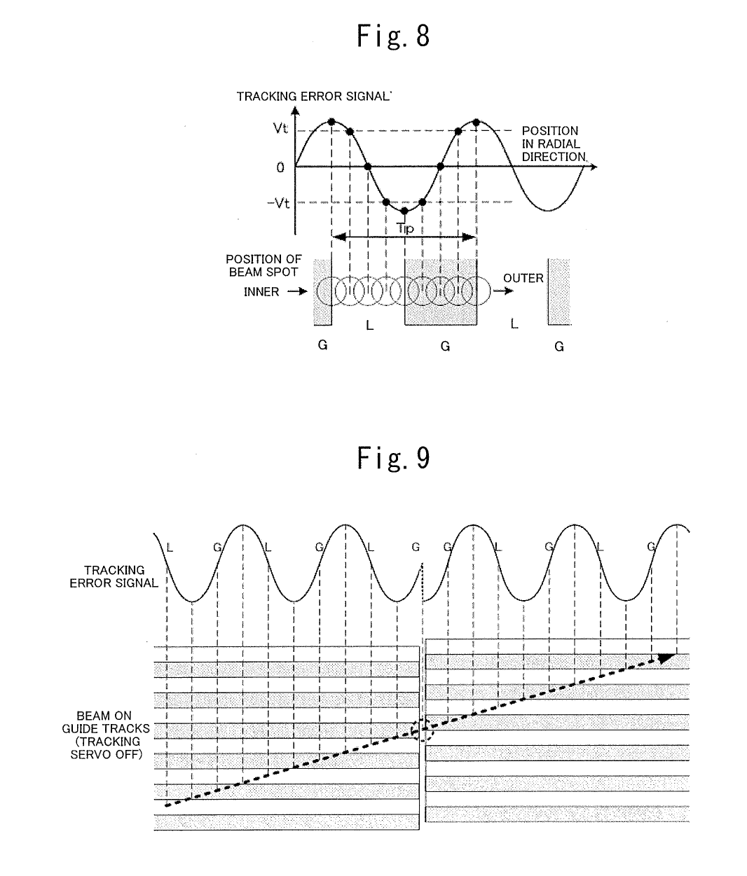

FIG. 8 shows the relationship between the spot position of the servo laser beam in the radial direction and the tracking error signal. The position of the beam spot shown in FIG. 8 is shifted over the lands L and grooves G from the inner side to outer side in units of Tp/8. The tracking error signal becomes zero when the position of the beam spot falls on the center of a land L or groove G. The tracking error signal peaks when the position of the beam spot falls on the border between a land L and a groove G, i.e., when the position is off the center of a land L or groove G by Tp/4. The tracking error signal shows a voltage level of ±Vt when the position of the beam spot is off the center of a land L or groove G by Tp/8. Conversely, when the tracking error signal shows +Vt and a land L is being tracked, the spot position is off the track by Tp/8 inward. When a groove G is being tracked, the spot position is off the track by Tp/8 outward. When the tracking error signal shows −Vt and a land L is being tracked, the spot position is off the track by Tp/8 outward. When a groove G is being tracked, the spot position is off the track by Tp/8 inward.

When tracking servo control is on, the tracking control section 36 performs a control operation so that the tracking error signal comes to the same level as that of the tracking target value. The tracking target value is typically set to zero which indicates the center of the track (land L or groove G). A nonzero target value can be provided to trace the guide track with a deviation from the track center. For example, if the tracking target value is set to Vt in FIG. 8, it is possible to trace the guide track with a deviation of Tp/8 from the track center. Here, the tracking error signal is approximately Vt in level, not the zero level.

FIG. 9 shows variations of the tracking error signal when the servo laser beam traverses the guide track composed of lands L and grooves G of the guide layer GL at constant speed. During the traverse, the tracking error signal reaches the zero level from lower left when the spot of the servo laser beam is on a groove G. The tracking error signal reaches the zero level from upper left when the spot of the servo laser beam is on a land L. The tracking error signal peaks when the spot of the servo laser beam is at the border between a land L and a groove G. When the beam spot of FIG. 9 traverses the discontinuous portion, the switching from the groove G to the border with the land (mirror surface) of the discontinuous portion makes the tracking error signal also discontinuous, with a change of 90 degrees in the phase of the tracking error signal.

Next, the operation of such an optical disk drive apparatus will be described in recording mode where information is recorded on a desired recording layer of the optical disk 10 (any one of the recording layers L0 to L2; for example, the recording layer L0).

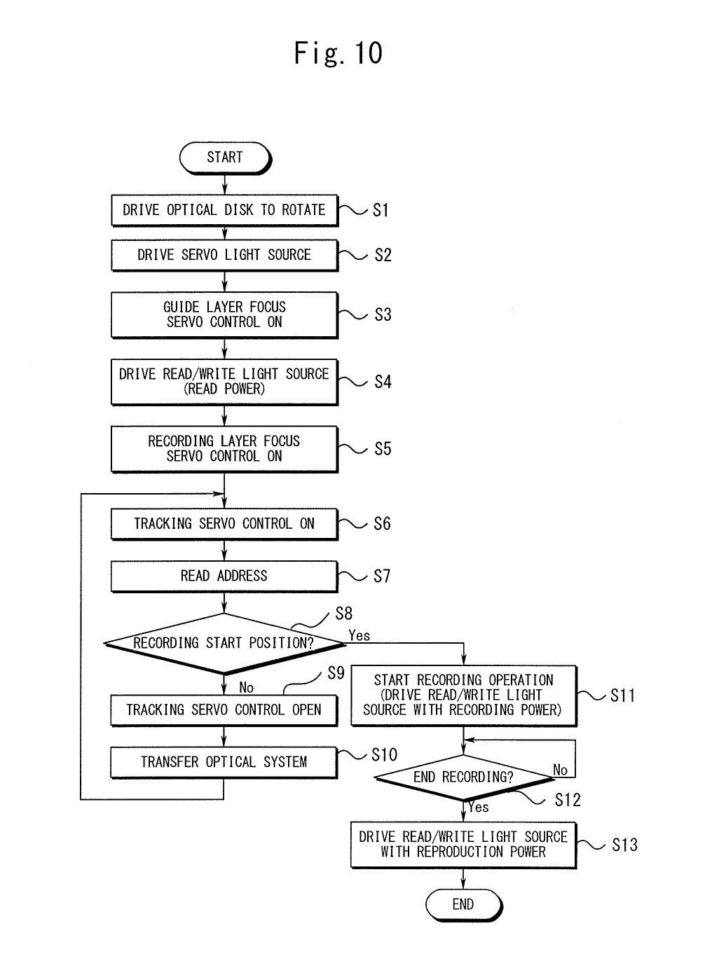

The main controller 45 starts the operation of the recording mode in accordance with a recording instruction from an operation part (not shown). As shown in FIG. 10, the main controller 45 initially issues a rotation start instruction to the recording medium rotation control section 31 so that the spindle motor 7 drives the optical disk 10 for rotation (step S1). The main controller 45 issues a light emission drive instruction to the servo light source drive section mentioned above (step S2). The servo light source drive section drives the light source 11 to emit the servo laser beam.

The main controller 45 instructs the guide layer focus control section 34 to turn the focus servo control on (step S3). With the focus servo control on, the servo optical system, the guide layer focus error generation section 33, the guide layer focus control section 34, and the objective lens drive section 37 form a focus servo loop. The guide layer focus control section 34 thus generates the guide layer focus control signal so that the focus error signal generated by the guide layer focus error signal generation section 33 comes to a zero level. The objective lens drive section 37 drives the focus actuator 16a. Consequently, the position of the objective lens 16 is controlled in the direction of the optical axis, whereby the focus of the servo laser beam is positioned on the guide layer GL of the optical disk 10 with the converged beam spot on the guide layer GL.

After the execution of step S3, the main controller 45 issues a light emission drive instruction to the read/write light source drive section mentioned above (step S4), and instructs the recording layer focus control section 42 to turn the focus servo control on (step S5). The read/write light source drive section drives the light source 21 with read power so that a read laser beam is emitted. With the focus servo control turned on at step S5, the read/write optical system, the recording layer focus error generation section 41, the recording layer focus control section 42, and the beam expander drive section 43 form a focus servo loop. The recording layer focus control section 42 thus generates the recording layer focus control signal so that the focus error signal generated by the recording layer focus error signal generation section 41 comes to a zero level. The beam expander drive section 43 drives the actuator 24c. The correcting lens 24a has been moved to the position corresponding to the desired recording layer in advance. Since the position of the correcting lens 24a, i.e., the distance between the correcting lenses 24a and 24b is controlled by the focus servo control, the focus of the read/write laser beam is positioned on the desired recording layer without fail.

After the execution of step S5, the main controller 45 instructs the tracking control section 36 to turn the tracking servo control on (step S6). Since the instruction to turn the tracking servo control on switches the tracking on/off switcher 69 to the ON side, the servo optical system, the guide layer tracking error generation section 35, the tracking control section 36, and the objective lens drive section 37 form a tracking servo loop. The tracking control section 36 thus generates the tracking control signal so that the tracking error signal generated by the guide layer tracking error signal generation section 35 comes to a tracking target level. The objective lens drive section 37 drives the tracking actuator 16b. Consequently, the position of the objective lens 16 is controlled in the radial direction of the disk, whereby the converged beam spot of the servo laser beam is positioned on the guide track of the guide layer GL of the optical disk 10. Meanwhile, in the desired recording layer, the converged beam spot of the read or write laser beam falls on the position corresponding to the guide track.

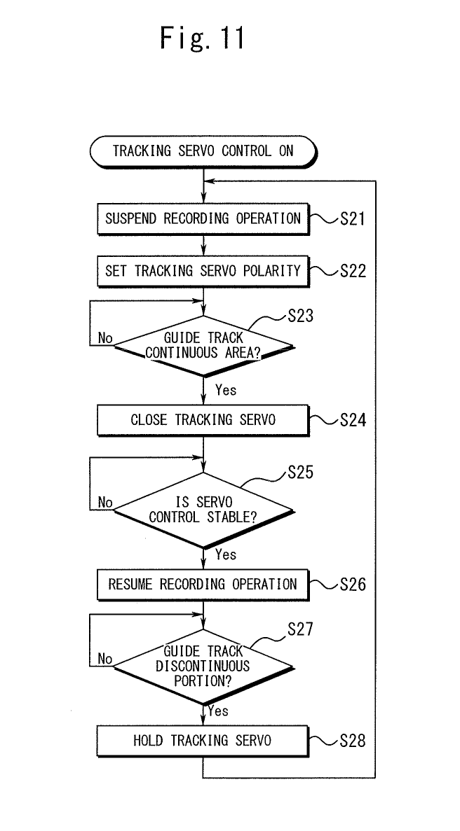

After the execution of step S6, the main controller 45 reads the address of the current track on the guide layer GL from the output signal of the guide layer reproduced-signal generation section 38 (step S7). Based on the current track address read, the main controller 45 determines whether the spot position of the servo laser beam is a recording start position (step S8). If not a recording start position, the main controller 45 instructs the tracking control section 36 to turn the tracking servo control off (step S9). The instruction to turn the tracking servo control off stops the control operation of FIG. 11 where the tracking servo control to be described later is on. The transfer drive section mentioned above transfers the optical systems so that the spot position of the servo laser beam moves to a track that is in the recording start position (step S10). The main controller 45 then returns to the execution of step S6.

If, at step S8, it is determined that the spot is in a recording start position, a recording operation is started from the recording start position of the desired recording layer by using the read/write laser beam (step S11). In the recording operation, the read/write light source drive section drives the light source 21 with recording power so that a recording laser beam is emitted. The laser beam is modulated in accordance with recording data that is supplied from not-shown means. Note that the recording operation can be suspended depending on the state of the tracking servo control.

After the start of the recording operation, the main controller 45 determines whether or not to end recording (step S12). For example, if all the recording data has been supplied and the recording operation is to be ended, the main controller 45 terminates the recording operation (step S13). At the end of the recording operation, the read/write light source drive section drives the light source 21 with the read power, restoring the state where the read laser beam is emitted.

When the tracking servo control is turned on at step S6, the main controller 45 starts a control operation on the discontinuous portions of the guide layer GL. In the control, as shown in FIG. 11, the main controller 45 issues an instruction to temporarily suspend the recording operation (step S21), and sets the tracking servo polarity by using the land/groove switcher 66 (step S22). To set the tracking servo polarity, the main controller 45 generates the land/groove select signal. When tracking a groove G after a discontinuous portion, the land/groove switcher 66 selects the output signal of the gain adjuster 64 in accordance with the land/groove select signal. When tracking a land L after a discontinuous portion, the land/groove switcher 66 selects the output signal of the polarity inverter 65 in accordance with the land/groove select signal. For each rotation of the optical disk 10 (two discontinuous portions), the land/groove switcher 66 switches the select position, i.e., the tracking servo polarity in accordance with the land/groove select signal.

After the execution of step S22, the main controller 45 determines whether or not the spot position of the servo laser beam lies in a guide track continuous area (step S23). The guide track continuous area refers to the area A1 or A2 other than the discontinuous portions. If the spot position is in a discontinuous portion, the current state is under tracking hold control with the recording suspended. If the spot position is in a guide track continuous area, the main controller 45 instructs that the tracking servo control be closed (step S24). With the instruction to close the tracking servo control, the tracking servo/hold switcher 68 switches to the tracking-on side and the tracking mode enters a tracking servo control state. After the closing of the tracking servo control, the main controller 45 determines whether or not the tracking servo control is stable (step S25). The stability of the tracking servo control is determined, for example, depending on the amplitude of the tracking error signal. More specifically, the tracking servo control is determined to be stable if the tracking error signal falls within the tracking target value±an allowable value. If the tracking servo control is determined to be stable, the main controller 45 resumes the recording operation (step S26).

Subsequently, the main controller 45 determines whether or not the spot position of the servo laser beam lies in a guide track's discontinuous portion (step S27). If in a discontinuous portion, the main controller 45 changes the tracking mode to a hold state by using the tracking servo/hold switcher 68 (step S28), and returns to step S21 to repeat the foregoing operations.

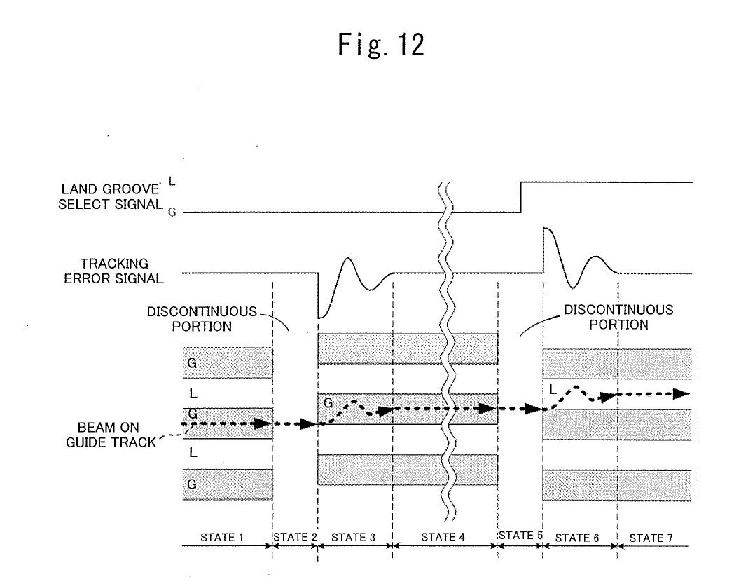

Referring to FIG. 12, a description will now be given of a tracking servo control operation that the optical disk drive apparatus of such a configuration performs on the guide tracks of the guide layer GL including the discontinuous portions.

Initially, suppose that the polarity of the tracking error signal (the level of the land/groove select signal) is determined by the land/groove switcher 66 so that the spot of the servo laser beam traces grooves G, and the tracking servo control is on. As in state 1 of FIG. 12, the tracking error signal has a near zero level, and the beam spot moves to trace the center of the groove G of the guide track. In such a stable state, recording is performed on any one of the recording layers L0 to L2.

The discontinuous portions have no guide track, and the tracking error signal disappears. In state 2 of FIG. 12, or in a discontinuous portion, the foregoing step S23 is performed to enter tracking hold control. The tracking servo/hold switcher 68 switches to the hold side, and relays the held output signal from the hold processing section 76 to the objective lens drive section 37 as the tracking control signal. Since the tracking servo control system is yet to be closed and is unstable, step S22 is performed to stop the recording operation. That is, in the tracking hold control state, the beam spot travels along the extension of the groove G of the guide track. A guide track subsequently appears again with a deviation of Tp/4 which is one half the width of the lands L and grooves G. The beam spot therefore falls on the border between a land L and the groove G of the guide track. When it is determined at step S25 that the discontinuous portion ends, step S26 is performed to turn the tracking servo control on. When the tracking servo control is turned on, the tracking error signal increases in amplitude due to disturbance of the tracking servo control as shown in state 3 of FIG. 12 in order to draw the beam spot back to the groove G of the guide track. Since the tracking servo control is still in an unstable state, recording is not performed yet. After a lapse of time since the beginning of state 3, the disturbance of the tracking servo control subsides and the tracking error signal comes to near zero as shown in state 4 of FIG. 12. State 4 is the same as state 1, and recording is performed again.

State 5 of FIG. 12 is where the beam spot passes a discontinuous portion as in state 2. Recording is thus stopped to enter the tracking hold state. Here, the land/groove switcher 66 inverts the polarity of the tracking error so that the beam spot traces lands L. Consequently, when state 6 of FIG. 12 is started and the tracking servo control is turned on again, the beam spot is controlled and drawn back from the border between the land L and the groove G to the land L, which disturbs the tracking servo control as in the foregoing state 3. After a lapse of time, the disturbance of the tracking servo control subsides and the tracking error signal comes to near zero as shown in state 7 of FIG. 12. Since the beam spot stably traces the land L, the recording operation is resumed again.

As seen above, when the tracking servo control is turned on (closed) at the end of a discontinuous portion, the beam spot is automatically drawn to the center of a land L or a groove G. If the tracking servo control has sufficiently short response time in the intervals of states 2 and 5, it is possible to branch into a land L or a groove G with the tracking servo control kept on (closed), without the hold processing. It is also possible to select which to trace, a land L or a groove G, by the land/groove switcher 66 selecting the polarity of the tracking servo control at appropriate timing.

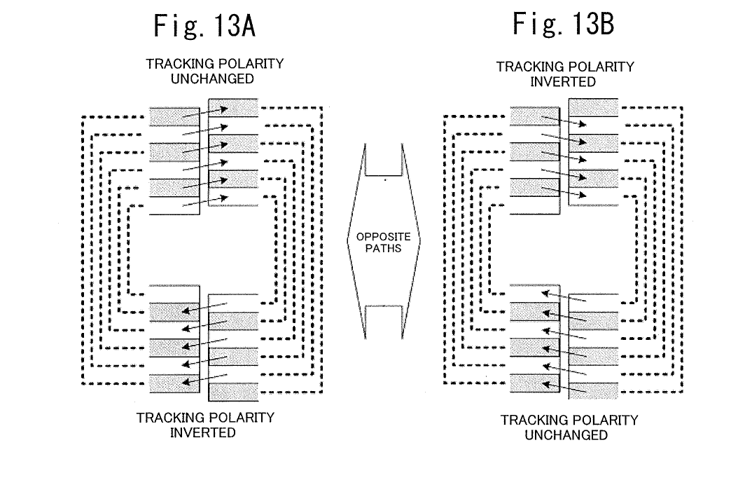

FIGS. 13A and 13B show by arrows the movement of the beam spot in the discontinuous portions when the beam spot traces the guide tracks of the guide layer GL clockwise. The beam spot passes two discontinuous portions while going round along the guide tracks. With the movement of the beam spot of FIG. 13A, the tracking polarity is maintained unchanged in one of the discontinuous portions (the upper discontinuous portion in FIG. 13A). The beam spot is thus controlled to move from a land L to a land L, or from a groove G to a groove G, across the discontinuous portion. In the other discontinuous portion (the lower discontinuous portion in FIG. 13A), the tracking polarity is inverted. The beam spot is thus controlled to move from a land L to a groove G, or from a groove G to a land L, across the discontinuous portion. Consequently, in either of the discontinuous portions, the beam spot shifts to a track that is located Tp/4 outside. The beam spot therefore moves gradually from the inner side to outer side of the disk 10.

With the movement of the beam spot of FIG. 13B, the tracking polarity is inverted in the one discontinuous portion (the upper discontinuous portion in FIG. 13B). The beam spot is thus controlled to move from a land L to a groove G, or from a groove G to a land L, across the discontinuous portion. In the other discontinuous portion (the lower discontinuous portion in FIG. 13B), the tracking polarity is maintained unchanged. The beam spot is thus controlled to move from a land L to a land L, or from a groove G to a groove G, across the discontinuous portion. Consequently, in either of the discontinuous portions, the beam spot shifts to a track that is located Tp/4 inside. The beam spot therefore moves gradually from the outer side to inner side of the disk 10.

In this way, the tracking servo polarity can be controlled in the discontinuous portions to implement opposite paths with a single guide track. For example, to record recording data across a plurality of recording layers L0 and L1, the beam spot is initially moved from inner to outer tracks of the guide layer GL as in FIG. 13A when data is recorded on the recording layer L0. Then, the beam spot is moved from outer to inner tracks of the guide layer GL as in FIG. 13B when data is recorded on the recording layer L1.

According to the foregoing embodiment, it is possible to form recording tracks of spiral shape on the recording layers L0 to L2 of the optical disk 10 at high density. As shown in FIGS. 13A and 13B, it is also possible to implement opposite paths with a single guide layer GL. Moreover, there is the advantage that the low frequency of the hold processing and polarity inversion in the tracking servo control increases the effective areas of the guide tracks that are available to generate recording clocks and acquire addresses. The guide tracks may have a concentric configuration, which can make the cutting of the guide layer relatively easy.

Suppose now that the disk drive apparatus of FIG. 5 is in reproducing mode, where the disk drive apparatus plays the optical disk 10 that has recording data recorded on at least one of its recording layers L0 to L2. In such a case, the read/write light source drive section drives the light source 21 with the read power. The tracking servo control is performed as with recording so that the spot of the read laser beam traces the recorded tracks. In accordance with the output signals of the photodetector 21 here, the recording layer reproduced-signal generation section 44 produces read data.

In reproducing mode, the recording layers of the optical disk already have recording tracks. The tracking error signal on the recording layers can thus be obtained from the output signals of the photodetector 21. In reproducing mode, it is therefore possible for the read/write optical system to perform servo control directly on the recording tracks for data read without using the guide track of the guide layer.

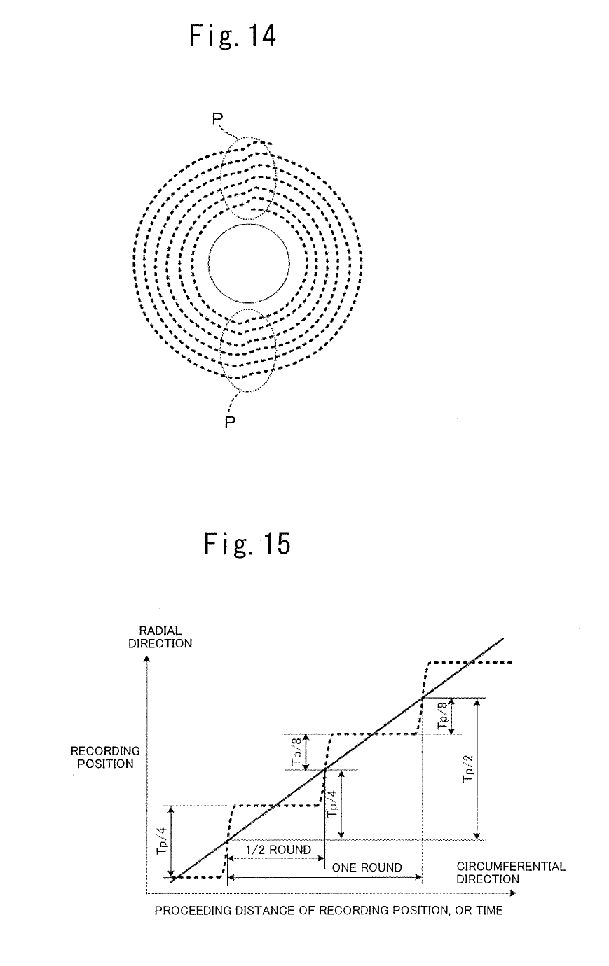

As shown in FIG. 14, the recording track formed on a recording layer as described in the embodiment has a spiral shape that is distorted in the portions P corresponding to the discontinuous portions of the guide tracks. In reproducing mode, the tracking servo control may fail to catch up with the abrupt changes of the recording track in the portions P corresponding to the discontinuous portions, possibly resulting in unstable servo control or even detracking which makes a data read impossible. The detection of the portions P corresponding to the discontinuous portions entails recording redundant data for detection, which causes a drop in storage capacity.

Next, a description will be given of tracking servo control such that the recording track recorded has a spiral shape that makes a constant change from the inner side to outer side.

In the present embodiment, both the lands and grooves of the guide layer are used for recording. The recording track therefore has a track pitch one half that of the guide track (Tp/2).

FIG. 15 shows variations of the recording position that proceeds from the inner side to outer side when recording the spiral recording track of FIG. 14. The horizontal axis indicates the proceeding distance of the recording position, or time. The vertical axis indicates the recording position in the radial direction. For example, on a recording track of spiral shape with a constant change, the recording position proceeds linearly as shown by the full line in FIG. 15. When tracing the guide tracks of FIG. 1 for recording, the recording position proceeds stepwise at each half round as shown by the broken line in FIG. 15. The recording track proceeds by ¼ the track pitch of the guide track for one continuous interval (half round). With respect to the recording track of spiral shape with a constant change (full line), the stepwise recording track (broken line) deviates by ±Tp/8 of the guide track in the discontinuous intervals. It is therefore possible to form the recording track of spiral shape with a constant change by intentionally shifting the recording track from −Tp/8 to +Tp/8 with respect to the guide track at recording time. As shown in FIG. 8, the intentional shift of the recording track with respect to the guide track can be achieved through the setting of the tracking target value. More specifically, when the tracking target value is gradually changed from −Vt to Vt during recording, the beam spot on the guide layer gradually changes from −Tp/8 to +Tp/8 with respect to the guide track. In terms of the radial direction of the disk, the beam spot on the recording layer and that on the guide layer make the same movement. The recording track recorded thus consequently has a spiral shape that gradually shifts from −Tp/8 to +Tp/8 with respect to the guide track.

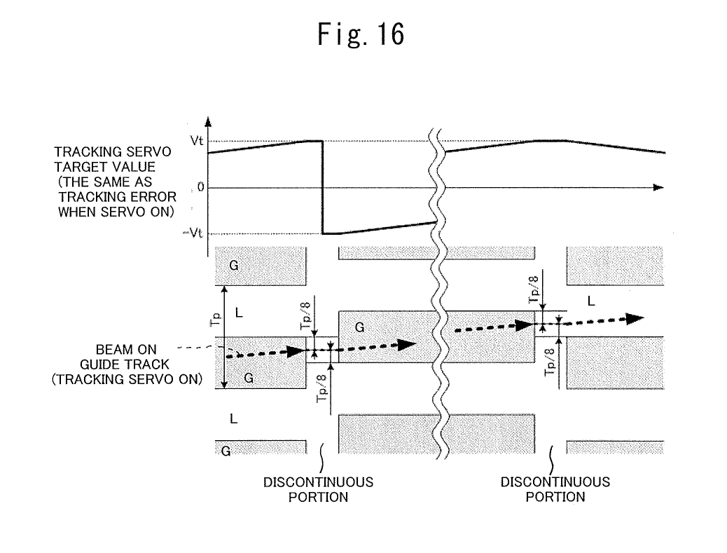

FIG. 16 shows the setting of the tracking target value in the discontinuous portions of the guide tracks and the movement of the servo beam spot on the guide tracks when forming a recording track of spiral shape that makes a constant change from the inner side to outer side. For example, when tracking from one groove G to another groove G across a discontinuous portion, the beam spot that proceeds straight changes from the state of being off center of the one groove G by Tp/8 outward to the state of being off center of the other groove G by Tp/8 inward. For such a tracking operation, the tracking target value is switched from +Vt (predetermined positive level) to −Vt (predetermined negative level) in the discontinuous portion. The switching of the tracking target value causes no shock since the tracking servo control is in the hold state in the discontinuous portion. Now, when the tracking is switched from a groove G to a land L across a discontinuous portion, for example, the beam spot that proceeds straight changes from the state of being off center of the groove G by Tp/8 outward to the state of being off center of the land L by Tp/8 inward. For such a tracking operation, the tracking target value of +Vt is maintained unchanged in the discontinuous portion. The reason is that the tracking servo polarity is switched in the discontinuous portion. That is, as shown in FIG. 8, the tracking error signal of being off center of the groove G by Tp/8 outward has the same level as that of the tracking error signal of being off center of the land L by Tp/8 inward. Outside the discontinuous portions, the tracking target value is gradually changed from −Vt to +Vt when the tracking servo control is performed to trace a groove G. The tracking target value is gradually changed from +Vt to −Vt when the tracking servo control is performed to trace a land L.

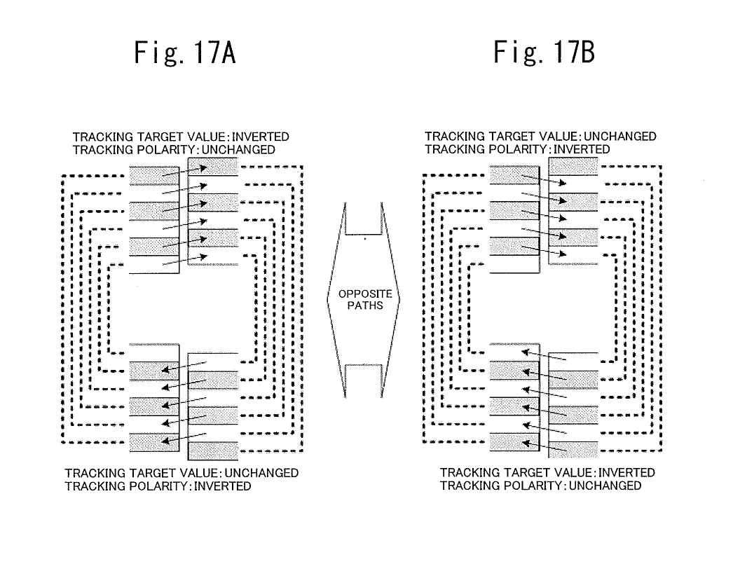

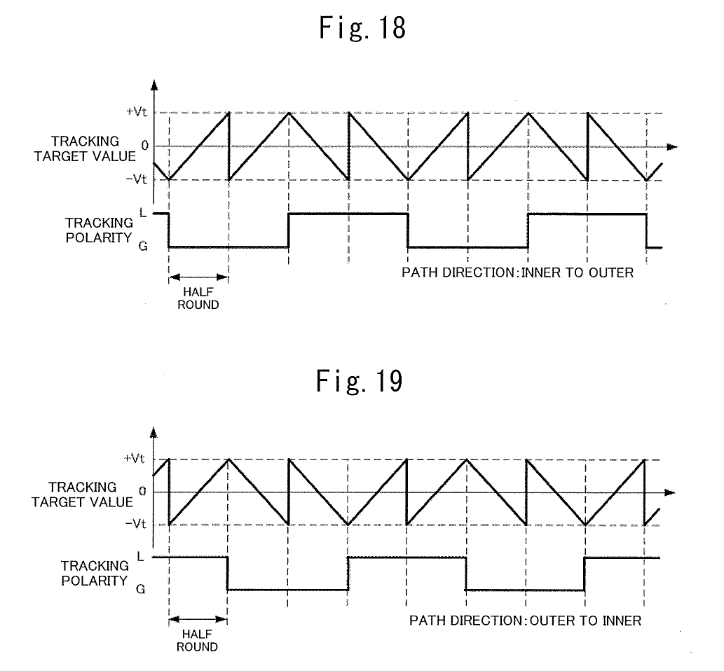

FIGS. 17A and 17B show by arrows the movement of the beam spot in the discontinuous portions when the beam spot traces the guide tracks of the guide layer GL clockwise in a spiral shape with a constant change. The beam spot passes two discontinuous portions while going round along the guide tracks. With the movement of the beam spot of FIG. 17A, the tracking target value is inverted and the tracking polarity is maintained unchanged in one of the discontinuous portions (the upper discontinuous portion in FIG. 17A). The beam spot is thus controlled to move from a land L to a land L, or from a groove G to a groove G, across the discontinuous portion. In the other discontinuous portion (the lower discontinuous portion in FIG. 17A), the tracking target value is unchanged and the tracking polarity is inverted. The beam spot is thus controlled to move from a land L to a groove G, or from a groove G to a land L, across the discontinuous portion. When the tracking target value and the tracking polarity are changed in accordance with the movement of the beam spot as shown in FIG. 18, the beam spot therefore moves in a spiral shape with a constant change from the inner side to outer side of the disk 10.

With the movement of the beam spot of FIG. 17B, the tracking target value is unchanged and the tracking polarity is inverted in the one discontinuous portion (the upper discontinuous portion in FIG. 17B). The beam spot is thus controlled to move from a land L to a groove G, or from a groove G to a land L, across the discontinuous portion. In the other discontinuous portion (the lower discontinuous portion in FIG. 17B), the tracking target value is inverted and the tracking polarity is unchanged. The beam spot is thus controlled to move from a land L to a land L, or from a groove G to a groove G, across the discontinuous portion. When the tracking target value and the tracking polarity are changed in accordance with the movement of the beam spot as shown in FIG. 19, the beam spot therefore moves in a spiral shape with a constant change from the outer side to inner side of the disk 10.

As described above, the tracking servo polarity can be controlled in the discontinuous portions to implement opposite paths with a single guide track even when forming recording tracks of spiral shape that make a constant change.

By such a tracking servo control, recording tracks of spiral shape are formed with a constant change and less distortion.

Such a tracking servo control also eliminates the need for a rapid movement of the beam spot when turning on the tracking servo control from the hold state upon the transition from a discontinuous portion to a land L or groove G. The continuous formation of the tracks in a spiral shape with a constant change improves the servo stability, which provides the effect of stable recording.

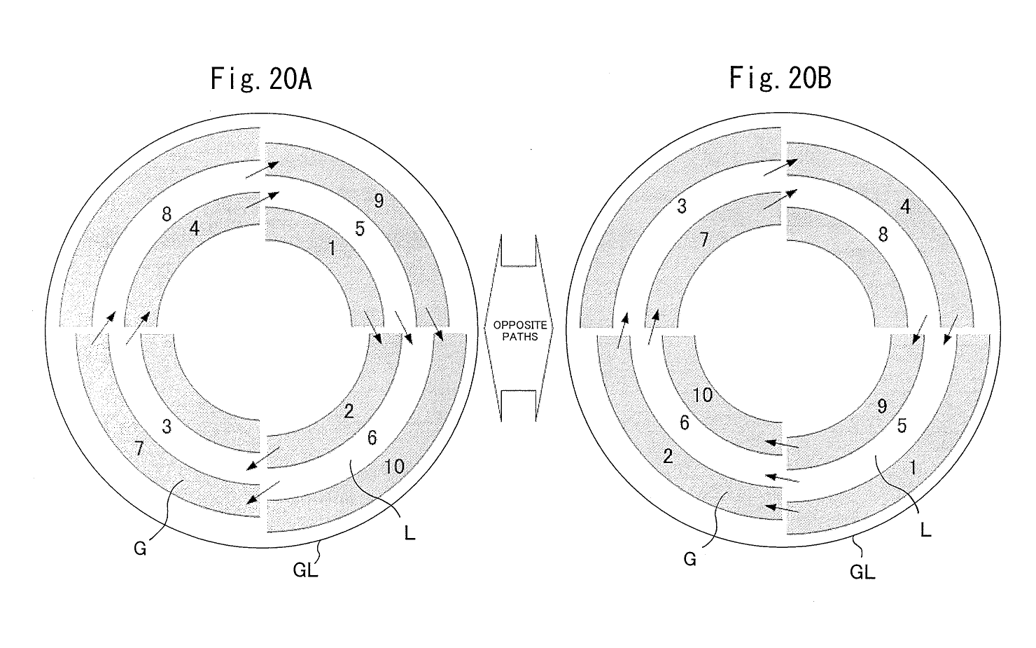

While the foregoing embodiment has dealt with the case where the guide layer of the optical disk is divided into the two areas A1 and A2, the guide layer may be divided into four areas by two mutually-orthogonal parting lines as shown in FIGS. 20A and 20B. The parting lines form discontinuous portions. There are four discontinuous portions per round. When moving on the optical disk from the inner side to outer side for recording, the grooves G and lands L are traced in the order shown by the numerals in FIG. 20A. When moving from the outer side to inner side for recording, the grooves G and lands L are traces in the order shown by the numerals in FIG. 20B.

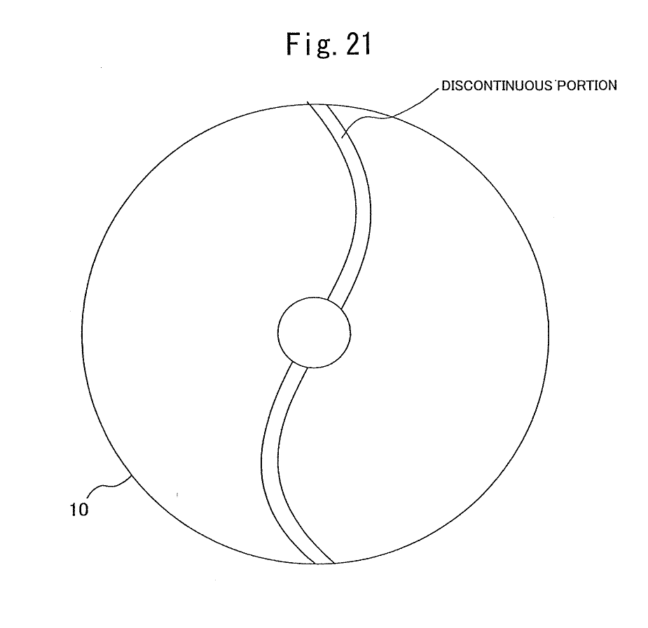

The foregoing embodiment has also dealt with the case where the discontinuous portions, which form the area parting line of the optical disk 10, are straight in shape. As shown in FIG. 21, the parting line for dividing the plurality of areas may be curved.

The present invention is applicable not only to an optical disk drive apparatus but also to other apparatuses such as a hard disk read/write apparatus that includes an optical disk drive apparatus.

1: A guide-layer separated optical disk, comprising:
a guide layer having a guide structure; and
a plurality of recording layers stacked separate from the guide layer, wherein
tracking guide tracks of the guide structure are divided into areas by discontinuous portions,
the areas each have concentric guide tracks of arc shape at a regular track pitch, and
the guide tracks in adjoining two of the areas across one of the discontinuous portions deviates from each other in a radial direction of the disk by ¼ the track pitch.

2: The guide-layer separated optical disk according to claim 1, wherein address information is recorded on the guide tracks.

3: The guide-layer separated optical disk according to claim 1, wherein the guide structure is divided into two areas by two discontinuous portions.

4: An optical disk drive apparatus for driving a guide-layer separated optical disk, the optical disk including a guide layer having a guide structure and a plurality of recording layers stacked separate from the guide layer, tracking guide tracks of the guide structure being divided into areas by discontinuous portions, the areas each having concentric guide tracks of arc shape at a regular track pitch, the guide tracks in adjoining two of the areas across one of the discontinuous portions deviating from each other in a radial direction of the disk by ¼ the track pitch, the optical disk drive apparatus comprising:
a servo optical system which irradiates the optical disk with a first laser beam for servo control through an objective lens to detect reflected light from the guide layer; and
a read/write optical system which irradiates the optical disk with a second laser beam for reading or writing through the objective lens to detect reflected light from one of the plurality of recording layers, wherein
the servo optical system includes a tracking servo control portion which switches a tracking center of an irradiation spot of the first laser beam between on the guide track and in between the guide tracks alternately each time the irradiation spot passes two of the discontinuous portions.

5: The optical disk drive apparatus according to claim 4, wherein
the tracking servo control portion includes:
a tracking error signal generation section which generates a tracking error signal based on a detection level of the reflected light in the servo optical system, the tracking error signal indicating an error of the irradiation spot of the first laser beam with respect to a center on the guide tracks or in between the guide tracks;
a tracking control section which generates a tracking control signal corresponding to a difference in level between the tracking error signal and a tracking target value;
a driving section which drives the objective lens in the radial direction of the disk in accordance with the tracking control signal; and
a polarity inverting section which inverts the tracking control signal in polarity in order to switch the tracking center of the irradiation spot between on the guide tracks and in between the guide tracks.

6: The optical disk drive apparatus according to claim 5, comprising a detection section which detects that the irradiation spot of the first laser beam exists on one of the discontinuous portions, and wherein
the tracking servo control portion include a holding section which holds, when the detection section detects that the irradiation spot exists on one of the discontinuous portions, the tracking control signal to be supplied to the driving section at a level immediately before the detection of the one discontinuous portion.

7: The optical disk drive apparatus according to claim 5, wherein the tracking target value is a zero level.

8: The optical disk drive apparatus according to claim 4, wherein when moving the irradiation spot of the first laser beam from an inner side to an outer side of the optical disk and when moving the irradiation spot of the first laser beam from the outer side to the inner side of the optical disk, said tracking servo control portion switches the tracking center of the irradiation spot between on the guide tracks and in between the guide tracks alternately at respective different ones of the discontinuous portions.

9: The optical disk drive apparatus according to claim 5, wherein:
when the irradiation spot of the first laser beam is tracking the guide tracks or between the guide tracks from an inner side to an outer side of the optical disk, the tracking target value is gradually changed from a predetermined negative level to a predetermined positive level having the same absolute value as that of the predetermined negative level if the tracking control signal has one polarity, and the tracking target value is gradually changed from the predetermined positive level to the predetermined negative level if the tracking control signal has the other polarity; and
when the irradiation spot of the first laser beam is tracking the guide tracks or between the guide tracks from the outer side to the inner side of the optical disk, the tracking target value is gradually changed from the predetermined positive level to the predetermined negative level if the tracking control signal has the one polarity, and the tracking target value is gradually changed from the predetermined negative level to the predetermined positive level if the tracking control signal has the other polarity.

10: The optical disk drive apparatus according to claim 5, wherein:
a center of the irradiation spot of the first laser beam gradually moves from an inward position by ¼ a track width to an outward position by ¼ the track width with respect to the center of the guide tracks when the irradiation spot is tracking the guide tracks from the inner side to the outer side of the optical disk, and the center of the irradiation spot of the first laser beam gradually moves from the inward position by ¼ the track width to the outward position by ¼ the track width with respect to the center between the guide tracks when the irradiation spot tracks between the guide tracks from the inner side to the outer side of the optical disk; and
the center of the irradiation spot of the first laser beam gradually moves from the outward position by ¼ the track width to the inward position by ¼ the track width with respect to the center of the guide tracks when the irradiation spot is tracking the guide tracks from the outer side to the inner side of the optical disk, and the center of the irradiation spot of the first laser beam gradually moves from the outward position by ¼ the track width to the inward position by ¼ the track width with respect to the center between the guide tracks when the irradiation spot is tracking between the guide tracks from the outer side to the inner side of the optical disk.

11: A tracking control method of an optical disk drive apparatus, the optical disk drive apparatus including: a servo optical system that irradiates a guide-layer separated optical disk with a first laser beam for servo control through an objective lens and detects reflected light from a guide layer of the optical disk, the optical disk including the guide layer and a plurality of recording layers stacked separate from the guide layer, the guide layer having a guide structure, tracking guide tracks of the guide structure being divided into areas by discontinuous portions, the areas each having concentric guide tracks of arc shape at a regular track pitch, the guide tracks in adjoining two of the areas across one of the discontinuous portions deviating from each other in a radial direction of the disk by ¼ the track pitch; and a read/write optical system that irradiates the optical disk with a second laser beam for reading or writing through the objective lens and detects reflected light from any one of the plurality of recording layers,
the tracking control method comprising the step of allowing the servo optical system to switches a tracking center of an irradiation spot of the first laser beam between on the guide tracks and in between the guide tracks alternately each time the irradiation spot passes two of the discontinuous portions.
